(19) United States
(12) Patent Application Publication
(10) Pub. No.: US 2009/0224171 A1
(43) Pub. Date: Sep. 10, 2009

(54) System and Method for Controlling Elution from a Radioisotope Generator with Electronic Pinch Valves

(76) Inventor: Arjan F. Verbokkem, Schraard (NL)

Correspondence Address: Mallinckrodt Inc., 675 McDonnell Boulevard, HAZELWOOD, MO, 63042, US

(21) Appl. No.: 12/305,474

(22) PCT Filed: Jul. 5, 2007
(86) PCT No.: PCT/US07/15566

§ 371 Date: Dec. 18, 2008

Related U.S. Application Data
(60) Provisional application No. 60/818,808, filed on Jul. 6, 2006.

(51) Int. Cl. G01N 21/01

(52) U.S. Cl. 250/430

(57) ABSTRACT

Embodiments of the present invention relate to a system and method for controlling an elution process with at least one electronic pinch valve. Specifically, embodiments of the present invention include supplying eluent to a radioisotope generator of a radioisotope elution system, and controlling elution of the radioisotope generator with at least one electronic pinch valve disposed on at least one flow line of the radioisotope elution system, wherein the electronic pinch valve is configured to either block flow through the at least one flow line or enable flow through the at least one flow line based on a state of the electronic pinch valve.

This application claims the benefit of U.S. Provisional Application No. 60/818,808, filed Jul. 6, 2006.

### FIELD OF THE INVENTION

The present invention relates generally to the field of nuclear medicine. Specifically, embodiments of the invention relate to a system and method for starting and stopping elution of radioisotopes from a radioisotope generator with electronic pinch valves.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Nuclear medicine is a branch of health science that utilizes radioactive material for diagnostic and therapeutic purposes by injecting a patient with a small dose of the radioactive material, which concentrates in certain organs or biological regions of the patient. Radioactive materials typically used for nuclear medicine include Technetium-99m, Indium-113m, and Strontium-87m among others. Some radioactive materials naturally concentrate toward a particular tissue; for example, iodine concentrates toward the thyroid. However, radioactive materials are often combined with a tagging or organ-seeking agent, which targets the radioactive material for a desired organ or biologic region of the patient. These radioactive materials alone or in combination with a tagging agent are typically defined as radiopharmaceuticals in the field of nuclear medicine. At relatively lower doses of the radiopharmaceutical, a radiation imaging system (e.g., a gamma camera) can provide an image of the organ or biological region that collects the radiopharmaceutical. Irregularities in the image are often indicative of a pathologic condition, such as cancer. Higher doses of the radiopharmaceutical may be used to deliver a therapeutic dose of radiation directly to the pathologic tissue, such as cancer cells.

The production of radiopharmaceuticals inherently involves radioactive material. Accordingly, it is desirable for clinicians and other individuals that work around radioisotope elution systems to limit their exposure to the elution process and its products. Indeed, many elution systems and related devices (e.g., transportation and dispensing mechanisms) include shielding that limits the exposure of users to radiation from the elution system and its products. However, even when shielding is present, it may be desirable to further limit exposure generally involved with engaging or disengaging flow controls in the radioisotope elution system. In addition, existing systems can expose the flow controls and other mechanisms to radiation, an eluent, or other materials involved with an elution process or subsequent cleaning. These materials can adversely affect the life and operability of the flow controls.

### SUMMARY

The present invention, in certain embodiments, is directed to a radioisotope elution system including electronic pinch valves disposed along flow lines of the radioisotope elution system. One or more electronic pinch valves may be positioned along the flow lines such that opening and closing the electronic pinch valves in defined combinations can stop and/or start an elution process. The electronic pinch valves may be arranged or configured to reduce the possibility of exposure of a user or operator to radiation from the elution system. For example, by preventing flow or controlling suction in components of the elution system, the electronic pinch valves may prevent or reduce the potential for spilling radioactive fluid when retrieving collected eluate from the elution system. Additionally, the electronic pinch valves may be configured for remote actuation, which may reduce the potential for exposing a user or operator to radiation from the elution system during operation. Further, the electronic pinch valves may be configured to avoid direct contamination of the valves themselves by operating to squeeze flow lines (e.g., tubing) together when closed and release the flow lines when open, thus avoiding direct contact between the valves and radioactive material and/or corrosive material in the flow lines.

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with a first aspect of the present invention, there is provided a radioisotope elution system, comprising a flexible radioisotope elution line, and an electronic pinch valve disposed externally about the flexible radioisotope elution line, wherein the electronic pinch valve includes a remote electronic control connector.

In accordance with a second aspect of the present invention, there is provided a radioisotope elution system, comprising a radioisotope generator, an elution line coupled to the radioisotope generator, wherein the elution line comprises a resilient circumferential wall disposed about a passage; and an electronic pinch valve disposed externally about the resilient circumferential wall.

In accordance with a third aspect of the present invention, there is provided a method, comprising electronically manipulating a state of at least one electronic pinch valve disposed externally about at least one resilient flow line of a radioisotope elution system between constricting and not constricting the at least one resilient flow line to control elution of a radioisotope generator.

Various refinements exist of the features noted above in relation to the various aspects of the present invention. Further features may also be incorporated in these various aspects as well. These refinements and additional features may exist individually or in any combination. For instance, various features discussed below in relation to one or more of the illustrated embodiments may be incorporated into any of the above-described aspects of the present invention alone or in any combination. Again, the brief summary presented above is intended only to familiarize the reader with certain aspects and contexts of the present invention without limitation to the claimed subject matter.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional view of an embodiment of a radioisotope elution system including electronic pinch valves;

FIGS. 2-6 are diagrams of various embodiments of a radioisotope elution systems including electronic pinch valves;

FIG. 7 is a flowchart illustrating an embodiment of a nuclear medicine process;

FIG. 8 is a diagram of an embodiment of a radiopharmaceutical preparation system; and

FIG. 9 is a diagram of an embodiment of a nuclear medicine imaging system.

### DETAILED DESCRIPTION OF SPECIFIC EMBODIMENTS

One or more exemplary embodiments of the present invention are described below. In an effort to provide a concise description of these embodiments, some features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Such a development effort would be a routine undertaking of design, fabrication, and manufacture for those of ordinary skill having the benefit of this disclosure.

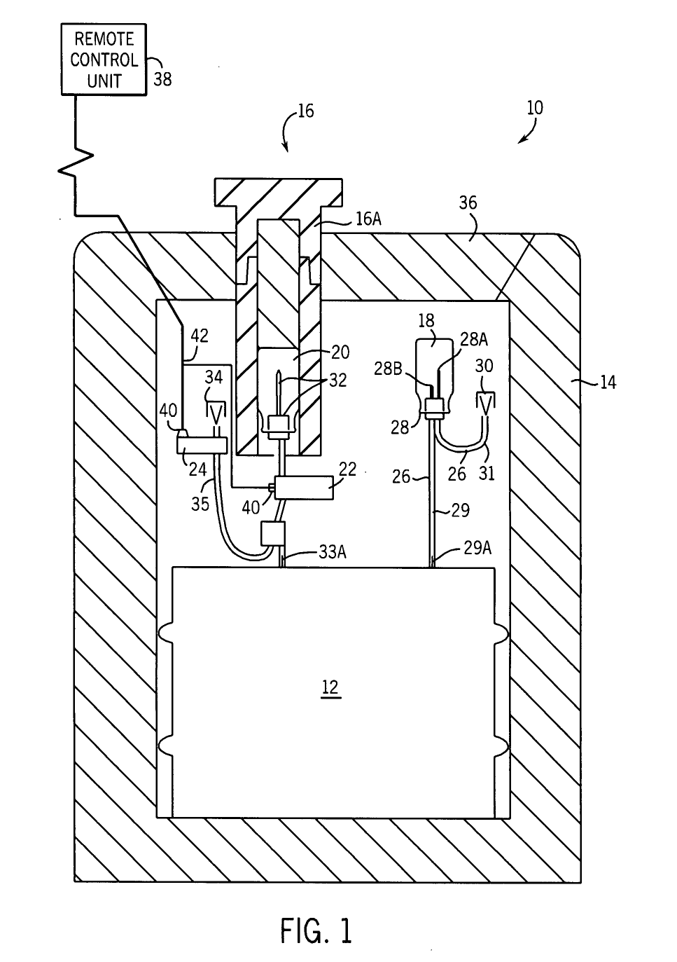

FIG. 1 is a cross-sectional side view of an embodiment of a radioisotope elution system 10 including a pair of electronic pinch valves 22,24 disposed on flow lines 26. It should be noted that a line may include a single line or a system of lines. The illustrated elution system 10 also may include a radioisotope generator 12, radiation shielding 14, an elution output assembly 16, an eluent supply bottle 18, and an eluate collection bottle 20. The elution output assembly 16 may include an elution shield 16A disposed about the eluate collection bottle 20. Each of the electronic pinch valves 22, 24 is coupled to a flow line 26 (e.g., resilient tubing) of the elution system 10 to facilitate automatic and/or remote control of an elution process being performed by the elution system 10. One or both of the electronic pinch valves 22, 24 may be disposed at least partially within the radioisotope generator 12.

In certain embodiments, the flow line 26 may include one or more lengths of resilient tubing in parallel or in series, or continuous, or intermittently coupled with other elution components, or a combination thereof. For example, a first portion of the flow line 26 may be disposed upstream from the radioisotope generator 12, while a second portion of the flow line 26 may be disposed downstream of the radioisotope generator 12. Together, the first and second portions may represent the overall elution flow line 26. The electronic pinch valves 22, 24 may be disposed externally about the flow line 26 on various upstream and/or downstream portions relative to the radioisotope generator 12 or in proximity to fluid connectors on the radioisotope generator 12. In certain embodiments, a system operator may remotely coordinate activation or deactivation of the first and second electronic pinch valves 22, 24 to stop or start an elution. Indeed, using the electronic pinch valves 22, 24, an operator or controller may cause the elution system 10 to complete a full or a partial elution (e.g., an elution to partially fill an eluate output container) without any radiation exposure. In other words, the operator can control liquid flow without opening the shielding 14, thereby substantially reducing the potential for radiation exposure.

During an elution procedure performed with the elution system 10, eluent (e.g., saline) flows from the eluent supply bottle 18 through the generator 12, and is collected as eluate in the eluate collection bottle 20. In the illustrated embodiment, the eluent supply bottle 18 is coupled to the generator 12 via a vented spike 28 and the tubing 26. The vented spike 28 includes an eluent vent needle 28A and a container eluent output needle 28B. The tubing 26 coupling the eluent supply 18 and the generator 12 may be referred to as an eluent input line 29 or eluent supply line 29. The eluent input line 29 may couple to the generator 12 via a generator eluent input needle 29A. The vented spike 28 may also couple to a vent 30 via the tubing 26 to regulate pressure and facilitate flow of eluent out of the eluent supply bottle 18. The tubing 26 between the vent 30 and the eluent supply bottle 18 may be referred to as a supply vent line, an eluent vent line, or an input vent line 31. The vent 30 may include a check valve to allow air into the eluent supply bottle 18 while generally preventing backflow from the eluent supply bottle 18 through the vent 30 and into other areas of the elution system 10. The tubing 26 between the eluent supply bottle 18 and the generator 12 (i.e., the eluent input line 29) may channel the eluent into the radioisotope generator 12 for flushing or generally eluting a daughter radioisotope from a parent radioisotope in the generator 12 and into the eluate collection bottle 20. The eluate collection bottle 20 may be coupled to the generator 12 via a hollow outlet needle 32 and the tubing 26 to facilitate such collection. The tubing 26 between the generator 12 and the eluate collection bottle 20 may be referred to as an eluate collection line 33 or eluate output line 33. The eluate output line 33 may couple to the generator 12 via a generator eluate output needle 33A.

The generator 12 may include a container or a shielded container designed to hold a parent radioisotope, such as Molybdenum-99, absorbed to alumina beads or another suitable exchange medium. Over time, the parent radioisotope may decay to produce a daughter radioisotope. For example, Molybdenum-99 may decay to form Technetium-99m as its daughter radioisotope. Molybdenum-99 has a half-life of approximately 67 hours. Thus, short-lived Technetium-99m, which has a half-life of approximately 6 hours, may continually be produced inside the generator 12 during operation. Once a certain amount of the radioisotope is present, the radioisotope elution system 10 may be ready for “milking.” In other words, the radioisotope may be ready to be collected from the generator 12 via an elution process, which may begin with flowing eluent through the generator 12. The daughter radioisotope (e.g., Technetium-99m) is held chemically less tightly than the parent radioisotope, thereby enabling flow of eluent to flush the desired daughter radioisotope from the radioisotope generator 12 into the eluate collection bottle 20 as a component of the eluate. In some embodiments, a wet elution process is utilized, wherein the generator 12 generally remains charged and eluate is removed via the eluate collection bottle 20 at designated times.

The eluate collection bottle 20 may have a standard or predefined volume. Additionally, the eluate collection bottle 20 may begin in an evacuated condition. Thus, when the eluate collection bottle 20 is attached to the elution system 10, it creates a suction or pressure drop into the eluate collection bottle 20. This pressure drop may essentially drive the elution system 10. For example, the suction of the eluate collection bottle 20 may draw the eluate residing in the generator 12 into the eluate collection bottle 20 via the tubing 26 and the outlet needle 32. In turn, the vacancy in the generator 12 created by moving the eluate into the eluate collection bottle 20 may result in eluent being drawn into the generator 12 from the eluent supply bottle 18. This transfer of eluent through the generator 12 facilitates production of more eluate containing the daughter radioisotope, which is being produced in the generator 12 from decay of the parent radioisotope. As set forth above, this process of collecting eluate may be referred to as “milking the cow,” i.e., milking the generator 12.

An elution process, such as that discussed above, being performed by the radioisotope elution system 10 can be started or stopped by blocking and/or unblocking certain flow paths (e.g., the eluent input line 29, the supply vent line 31, and/or the eluate output line 33) in the elution system 10. This blocking and unblocking may be achieved using the first and second electronic pinch valves 22, 24 to block and unblock flow lines 26 in the elution system 10. For example, in the embodiment illustrated by FIG. 1, the first electronic pinch valve 22 may be disposed on the tubing 26 extending between the generator 12 and the eluate collection bottle 20 (i.e., the eluate output line 33). Accordingly, by closing (e.g., activating constriction components) the first electronic pinch valve 22, which may externally squeeze the resilient tubing 26 to a closed position, eluate may be substantially or entirely prevented from being drawn into the eluate collection bottle 20 by the suction therein. By reopening (e.g., releasing the constriction components) the first electronic pinch valve 22, which allows the resilient tubing 26 to expand, flow may be reinitiated. Additionally, the second electronic pinch valve 24 may be disposed on tubing 26 between the eluate collection bottle 20 and a collection bottle vent 34. The tubing 26 between the eluate collection bottle 20 and the collection bottle vent 34 may be referred to as the collection vent line 35, the eluate vent line 35, or the output vent line 35. This second electronic pinch valve 24 may control flow of air or gas at a standard pressure (e.g., atmospheric pressure) into the eluate collection bottle 20. Because the elution system 10 may be driven by the suction created by the vacuum in the eluate collection bottle 20, normalizing the eluate collection bottle 20 by opening the second electronic pinch valve 24 may stop the elution process. In some embodiments, as illustrated in FIG. 1, to stop the elution process, the first electronic pinch valve 22 may be closed in conjunction with opening the second electronic pinch valve 24. In other embodiments, different valve arrangements may be utilized to start and stop flow, as discussed in detail below. It should be noted that while two electronic pinch valves are represented, other embodiments may utilize a single electronic pinch valve or multiple electronic pinch valves to control elution and reduce radiation exposure. It should further be noted that in some embodiments the elution system 10 may be driven by increasing pressure (e.g., via a pump) in certain portions of the system 10 to drive the elution, rather than driving the elution with a vacuum in the collection portion of the system 10.

Various benefits arise from utilizing the electronic pinch valves 22, 24 in a radioisotope elution system in accordance with various embodiments. For example, a user can substantially avoid or reduce potential exposure to the radioactive substances utilized in the elution process by activating or deactivating (e.g., opening and closing the valves) remotely. Indeed, the user can stand a great enough distance away from the elution system 10 to eliminate any potential effects of radiation from system 10. This may be achieved by utilizing a remote control unit 38 that communicatively couples to remote electronic control connectors 40 on one or both of the valves 22, 24 via a remote electronic control lead 42. Additionally, the fact that the electronic pinch valves 22, 24 are configured to squeeze the tubing 26 to stop flow may allow for reuse of the valves 22, 24, because the electronic pinch valves 22, 24 may avoid contamination from direct contact with radioactive material in the system 10. In other words, the eluent and eluate containing the daughter radioisotope may be generally contained within the generator 12, bottles 18, 20, and tubing 26, rather than directly passing through the valves 22, 24. Further, the arrangement of the valves in the elution system 10 may substantially reduce the potential for spillage. For example, in a typical elution system, removing the collection bottle 20 may result in a certain amount of eluate leakage from the outlet needle 32. A higher likelihood of leakage may exist when a vacuum remains in the collection bottle 20 at the time of removal. Specifically, for example, the collection bottle 20 may be utilized for a partial elution, and, when the partial elution is complete, the bottle 20 may retain a vacuum. Thus, upon removing a lid 36 or elution assembly 16, and retrieving the collection bottle 20 from the outlet needle 32, a certain amount of eluate may be pulled out of the outlet needle 32 and onto other portions of the elution system 10 or potentially elsewhere. The risk of such spillage and the related radiation exposure may be eliminated or substantially reduced by normalizing the collection bottle 20 and blocking eluate flow using the electronic pinch valves 22, 24. It should be noted that certain embodiments may incorporate automatic delays between opening and closing particular valves to facilitate flow or to generally prevent spills.

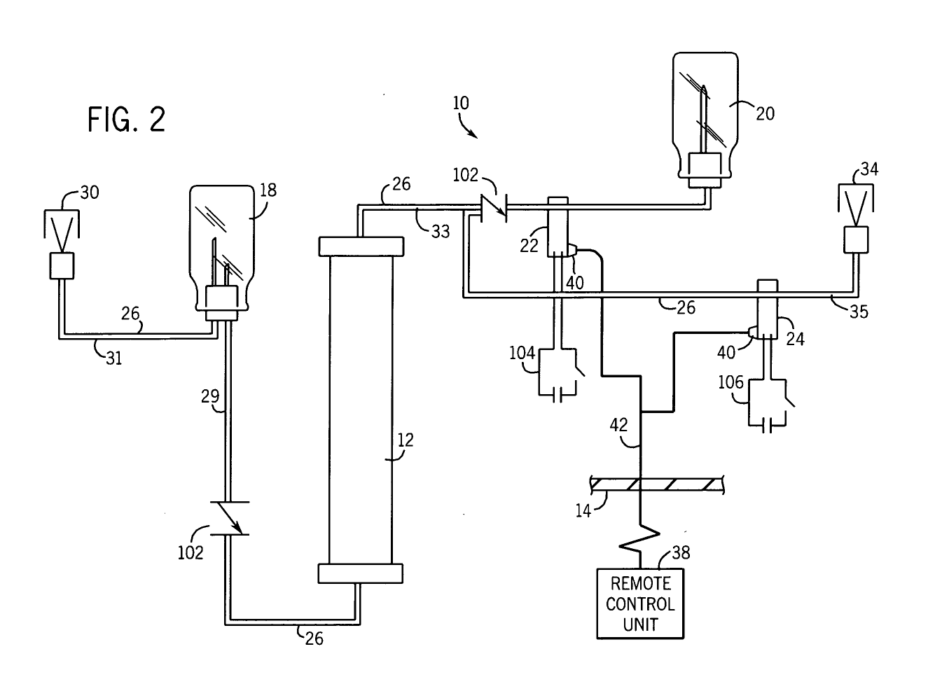

FIG. 2 is a perspective diagrammatical view of an embodiment of a radioisotope elution system 10 including electronic pinch valves 22, 24. Specifically, FIG. 2 depicts internal components of the elution system 10 that may include the generator 12, the eluent supply bottle 18, the eluate collection bottle 20, the tubing 26, the vent 30, the vent 34, the first electronic pinch valve 22, and the second electronic pinch valve 24. The illustrated embodiment also may include check valves 102 disposed along the tubing 26 and arranged to generally prevent or reduce the potential for backflow in the system 10. Further, the illustrated embodiment includes the remote control unit 38 communicatively coupled to the remote electronic control connectors 40 of the valves 22,24 via the remote electronic control lead 42. It should be noted that some embodiments do not include any check valves 102.

While other electronic valve types may be utilized, FIG. 2 depicts the electronic pinch valves 22, 24 as solenoid valves. A solenoid valve may be defined as an electromechanical valve that is controlled by running (or not running) an electrical current through a solenoid (i.e., a loop of wire which produces a magnetic field when current is passed through it), which changes the state (i.e., open or closed) of the valve. For example, by closing circuits 104 and 106, a coil in each of the electronic pinch valves 22, 24 may be caused to produce a magnetic field, thus causing the electronic pinch valves 22, 24 to open or close depending on the configuration. This may be achieved remotely using the remote control unit 38. The electronic pinch valves 22, 24 may be biased open or closed in a fail-safe state by a spring (e.g., a resilient coil or resilient tubing). For example, the electronic pinch valves 22, 24 may be biased open by the tubing 26 itself, which is in a compressed state when the electronic pinch valves 22, 24 are closed.

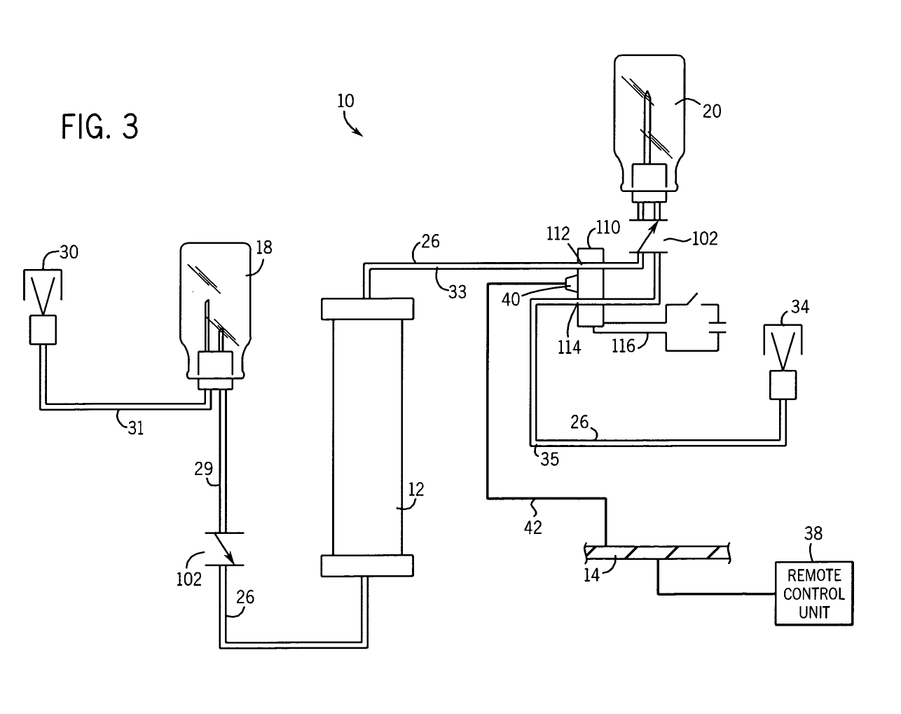

As discussed above with respect to FIG. 1, the arrangement of the electronic pinch valves 22, 24 in FIG. 2 may directly stop flow of eluate to the collection bottle 20 by sealing the tubing 26 downstream from the generator 12, between the generator 12 and the collection bottle 20 (i.e., the eluate output line 33), and indirectly stop eluate flow by normalizing the collection bottle 20 with the atmosphere by controlling the collection vent line 35. In one embodiment, this may be achieved using a single valve, as illustrated in FIG. 3. Specifically, FIG. 3 illustrates a dual action electronic pinch valve 110 that includes a first adjustable receptacle 112 and a second adjustable receptacle 114. The electronic pinch valve 110 may be configured to close the first adjustable receptacle 112 in coordination with opening the second adjustable receptacle 114 and vice versa. For example, the tubing 26 between the generator 12 and the collection bottle 20 may be placed in the first adjustable receptacle 112 and the tubing 26 between the vent 34 and the collection bottle 20 may be placed in the second adjustable receptacle 114. When the electronic pinch valve 110 is actuated, it may open the first adjustable receptacle 112 and close the second adjustable receptacle 114 to facilitate flow of eluate into the collection bottle 20. Alternatively, the electronic pinch valve 110 may close the first adjustable receptacle 112 and open the second adjustable receptacle 114 to prevent eluate flow into the collection bottle 20. This actuation may be facilitated by a biasing spring that is disposed within the valve and that biases the electronic pinch valve 110 toward a fail-safe position. Further, the actuation may be controlled by opening or closing a circuit 116 that provides electrical current to an activating mechanism (e.g., a solenoid) in the electronic pinch valve 110.

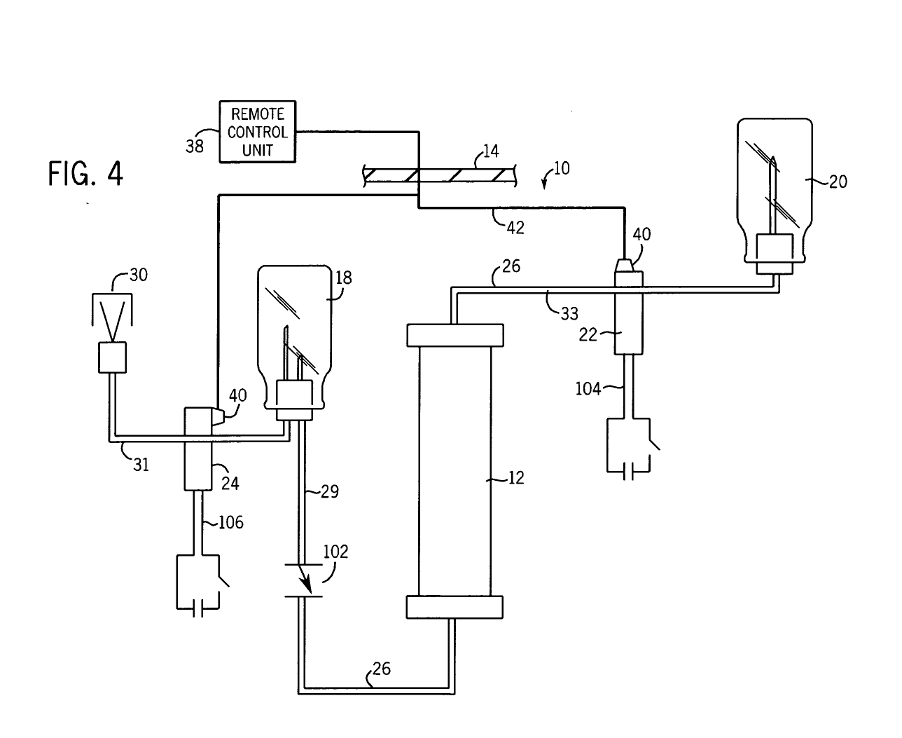

FIG. 4 is a perspective diagrammatical view of another embodiment of a radioisotope elution system 10 including electronic pinch valves 22, 24. Much like FIG. 2, the embodiment of FIG. 4 depicts internal components of the elution system 10, which may include the generator 12, the eluent supply bottle 18, the eluate collection bottle 20, the tubing 26, the vent 30, the first electronic pinch valve 22, and the second electronic pinch valve 24. The embodiment illustrated in FIG. 4 may also include check valves 102 disposed along the tubing 26 that prevent backflow in the system 10. Further, the embodiment illustrated by FIG. 4 may also include the remote control unit 38. However, in contrast to the embodiment illustrated by FIG. 2, the embodiment illustrated by FIG. 4 includes the second electronic pinch valve 24 disposed on the tubing between the vent 30 and the eluent supply bottle 18 (i.e., the supply vent line 31). By disposing the second electronic valve 24 in this location, suction can be created in the eluent supply bottle 18. For example, the second electronic pinch valve 24 can be closed as eluent flows out of the eluent supply bottle 18 to stop an elution process. By closing the second electronic valve 24 in this embodiment, flow into the eluent supply bottle 18 may be substantially blocked or restricted as liquid pressures equalize on input and output sides of the generator 12. Thus, volume lost as the eluent flows out of the eluent supply bottle 18 and into the generator 12 is not replaced. This may initially create suction or back pressure in the eluent supply bottle 18 and, thus, prevent further flow of eluent out of the eluent supply bottle 18 and into the generator 12. In other words, closing the second electronic pinch valve 24 over the tubing 26 between the vent 30 and the eluent supply bottle 18 (i.e., the supply vent line 31) may result in stopping an elution process as the elution system becomes closed upstream and the pressures equalize. Additionally, in the illustrated embodiment, the first electronic pinch valve 22 is disposed on the tubing between the generator 12 and the collection bottle 20 (i.e., the eluate output line 33). This valve 22 may also be closed, which may directly prevent or reduce the potential for the eluate to flow into the collection bottle 20 and, thus, generally stop an elution process. In accordance with present embodiments, these electronic pinch valves 22, 24 may be coordinated or utilized separately to start and stop an elution process by respectively opening and closing the electronic pinch valves 22, 24.

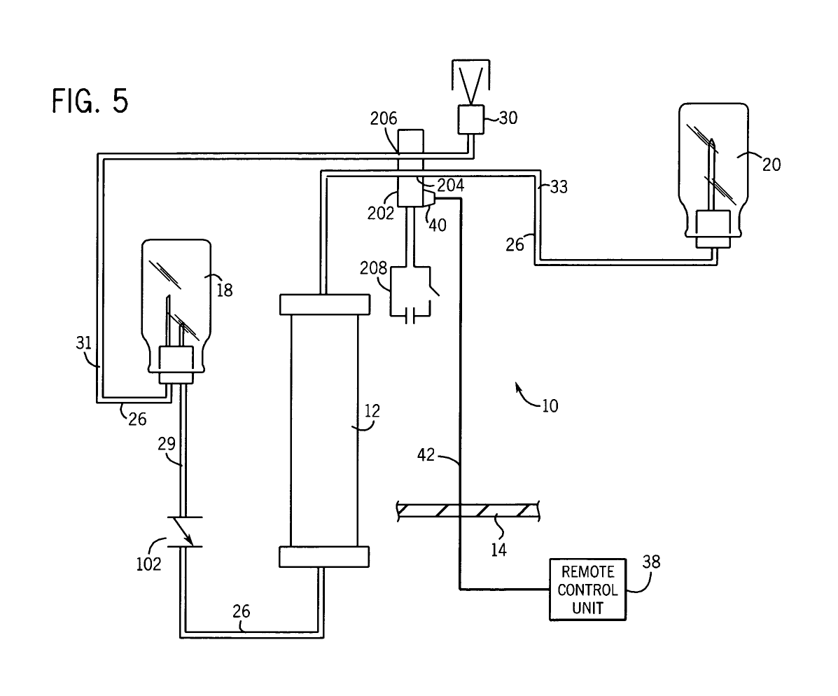

The embodiment illustrated by FIG. 4 utilizes two separate electronic pinch valves 22, 24 to squeeze or release the tubing 26 in the elution system to generally block or facilitate flow in the elution process. Thus, the two electronic pinch valves 22, 24 may be utilized to control the elution process (e.g., perform partial elutions) and provide added protection to a user from exposure to radioactive material in the process. In some embodiments, it is desirable to create back pressure or initial suction in the eluent supply bottle 18 upstream from the generator 12 in conjunction with blocking flow downstream between the generator 12 and the collection bottle 20 (i.e., the eluate output line 33). Thus, in the embodiment illustrated by FIG. 4, both of the electronic pinch valves 22, 24 may be used in upstream and downstream positions relative to the generator 12. However, as illustrated in FIG. 5, in some embodiments a single valve may be utilized to perform this flow control task. Specifically, FIG. 5 illustrates a dual action electronic pinch valve 202 that includes a first adjustable receptacle 204 and a second adjustable receptacle 206. The electronic pinch valve 202 may be configured to close the first adjustable receptacle 204 in coordination with closing the second adjustable receptacle 206 and vice versa. For example, the tubing 26 between the generator 12 and the collection bottle 20 may be placed in the first adjustable receptacle 204 and the tubing 26 between the vent 30 and the eluent supply bottle 18 may be placed in the second adjustable receptacle 206. In other words, the same electronic pinch valve 202 may be coupled to tubing at both upstream and downstream positions relative to the generator 12. Thus, the same valve 202 may produce both back pressure via the receptacle 206 and downstream blocking to substantially block flow on both inlet and outlet sides of the generator 12. When the electronic pinch valve 202 is actuated, it may open the first adjustable receptacle 204 and the second adjustable receptacle 206 or close the receptacles 204, 206 to facilitate or stop flow of eluate into the collection bottle 20, respectively. This actuation may be controlled by opening or closing a circuit 208 that provides electrical current to an activating mechanism (e.g., a solenoid) in the electronic pinch valve 202.

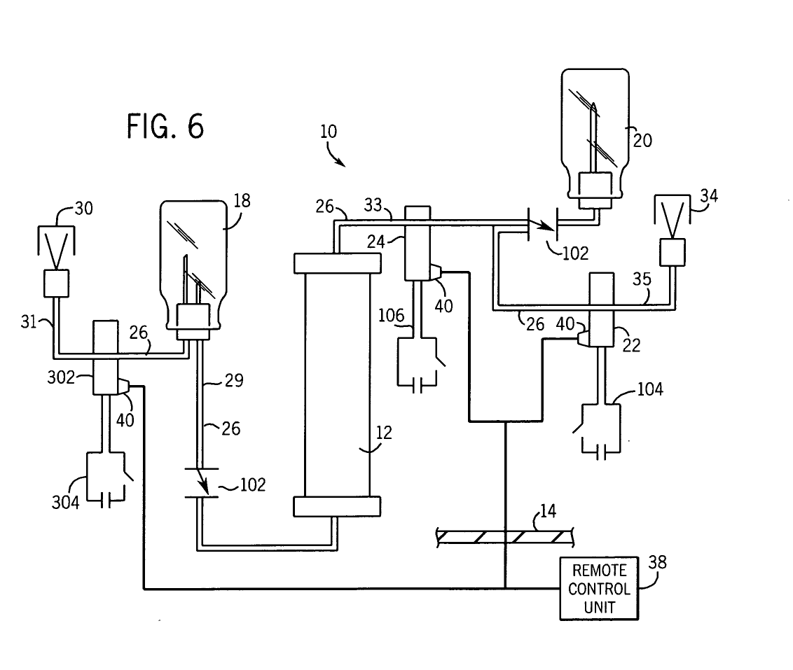

FIG. 6 is a perspective diagrammatical view of a further embodiment of a radioisotope elution system 10 including electronic pinch valves 22, 24, 302. FIG. 6 represents an exemplary embodiment that demonstrates that various valve arrangements and multiple valves may be utilized to control elution processes in accordance with present embodiments. Much like FIGS. 2, 3, 4, and 5, the embodiment of FIG. 6 depicts internal components of the elution system 10, which may include the generator 12, the eluent supply bottle 18, the eluate collection bottle 20, the tubing 26, the vent 30, the vent 34, the first electronic pinch valve 22, and the second electronic pinch valve 24. The embodiment illustrated in FIG. 6 also may include check valves 102 disposed along the tubing 26 that generally prevent or reduce the potential for backflow in the system 10. However, the embodiment illustrated in FIG. 6 is distinct from the embodiments discussed above because it includes a third electronic pinch valve 302. The first electronic pinch valve 22 may be disposed on the tubing 26 between the collection bottle 20 and the vent 34 (i.e., the output vent line 35). The second electronic pinch valve 24 may be disposed on the tubing 26 between the generator and the collection bottle 20 (i.e., the eluate collection line 33). The third electronic pinch valve 302 may be disposed on the tubing 26 between the vent 30 and the eluent supply bottle 18 (i.e., the input vent line 31), and may be actuated by opening or closing a circuit 304. Each of these valves 22, 24, 302 may be coordinated or utilized separately to control the elution process, as discussed above.

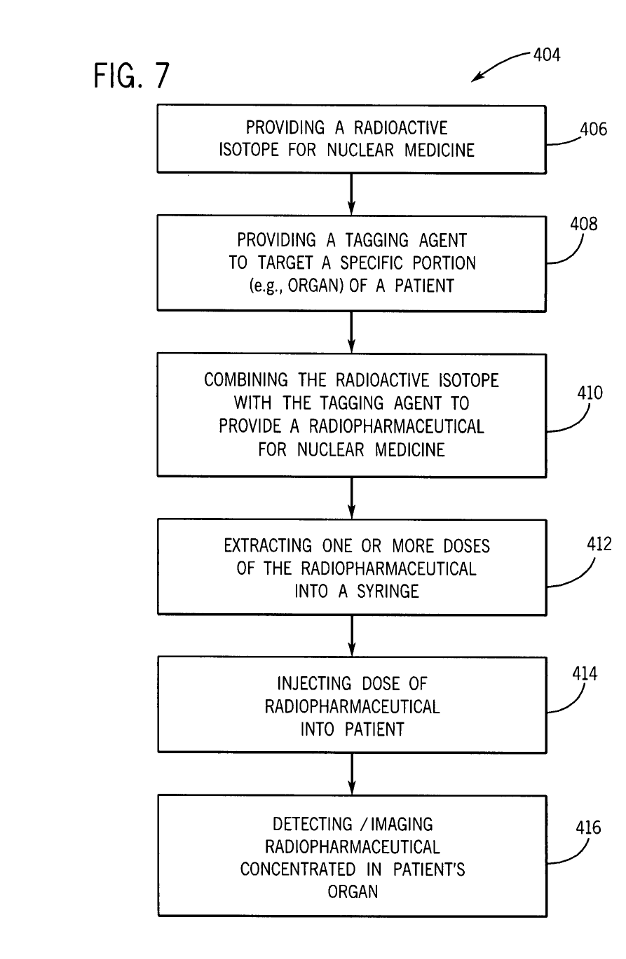

FIG. 7 is a flowchart illustrating an exemplary nuclear medicine process 404 utilizing the radioactive isotope produced by the elution system 10 as illustrated in FIGS. 1-6. As illustrated, the process 404 begins with providing a radioactive isotope for nuclear medicine at block 406. For example: block 406 may include eluting technetium-99m from the radioisotope generator 12, which is illustrated and described in detail above. Such an elution may be started and stopped using electronic pinch valves 22, 24, as discussed above. At block 408, the process 404 proceeds by providing a tagging agent (e.g., an epitope or other appropriate biological directing moiety) adapted to target the radioisotope for a specific portion, e.g., an organ, of a patient. At block 410, the process 404 proceeds by combining the radioactive isotope with the tagging agent to provide a radiopharmaceutical for nuclear medicine. In certain embodiments, the radioactive isotope may have natural tendencies to concentrate toward a particular organ or tissue. Thus, the radioactive isotope may be characterized as a radiopharmaceutical without adding any supplemental tagging agent. At block 412, the process 404 may proceed by extracting one or more doses of radiopharmaceutical into a syringe or another container, such as a container suitable for administering the radiopharmaceutical to a patient in a nuclear medicine facility or hospital. At block 414, the process 404 proceeds by injecting or generally administering a dose of the radiopharmaceutical into a patient. After a pre-selected time, the process 404 proceeds by detecting/imaging the radiopharmaceutical tagged to the patient's organ or tissue (block 416). For example, block 416 may include using a gamma camera or other radiographic imaging device to detect the radiopharmaceutical disposed on or in or bound to tissue of a brain, a heart, a liver, a tumor, a cancerous tissue, or various other organs or diseased tissue.

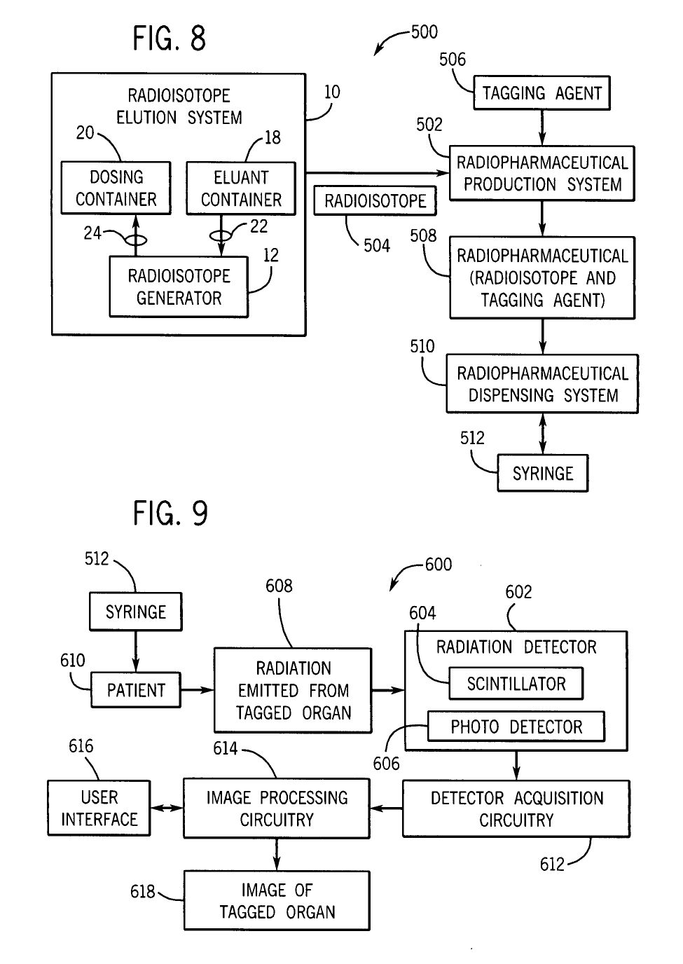

FIG. 8 is a block diagram of an exemplary system 500 for providing a syringe or container having a radiopharmaceutical produced in accordance with present embodiments disposed therein for use in a nuclear medicine application. As illustrated, the system 500 includes the radioisotope elution system 10 previously described with regard to FIGS. 1-6, wherein electronic pinch valves (e.g., 22, 24) are utilized to control system elutions. The system 500 also includes a radiopharmaceutical production system 502, which functions to combine a radioisotope 504 (e.g., technetium-99m eluate acquired through use of the radioisotope elution system 10) with a tagging agent 506. In some embodiment, this radiopharmaceutical production system 502 may refer to or include what are known in the art as “kits” (e.g., Technescan® kit for preparation of a diagnostic radiopharmaceutical). Again, the tagging agent 506 may include a variety of substances that are attracted to or targeted for a particular portion (e.g., organ, tissue, tumor, cancer, etc.) of the patient. As a result, the radiopharmaceutical production system 502 produces or may be utilized to produce a radiopharmaceutical including the radioisotope 504 and the tagging agent 506, as indicated by block 508. The illustrated system 500 may also include a radiopharmaceutical dispensing system 510, which facilitates extraction of the radiopharmaceutical into a vial or syringe 512. In certain embodiments, the various components and functions of the system 500 are disposed within a radiopharmacy, which prepares the syringe 512 of the radiopharmaceutical for use in a nuclear medicine application. For example, the syringe 512 may be prepared and delivered to a medical facility for use in diagnosis or treatment of a patient.

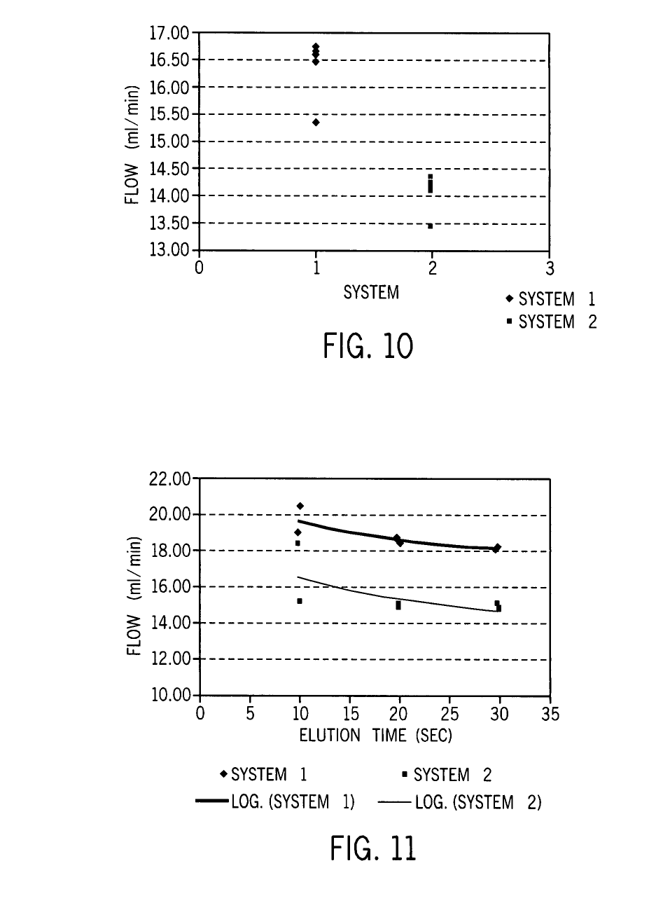

FIG. 9 is a block diagram of an exemplary nuclear medicine imaging system 600 utilizing the syringe 512 of radiopharmaceutical provided using the system 500 of FIG. 8. As illustrated, the nuclear medicine imagining system 600 includes a radiation detector 602 having a scintillator 604 and a photo detector 606. In response to radiation 608 emitted from a tagged organ within a patient 610, the scintillator 604 emits light that is sensed and converted to electronic signals by the photo detector 606. The imaging system 600 also can include a collimator to collimate the radiation 608 directed toward the radiation detector 602. The illustrated imaging system 600 also may include detector acquisition circuitry 612 and image processing circuitry 614. The detector acquisition circuitry 612 generally controls the acquisition of electronic signals from the radiation detector 602. The image processing circuitry 614 may be employed to process the electronic signals, execute examination protocols, and so forth. The illustrated imaging system 600 also may include a user interface 616 to facilitate user interaction with the image processing circuitry 614 and other components of the imaging system 600. As a result, the imaging system 600 produces an image 618 of the tagged organ within the patient 610. Again, the foregoing procedures and resulting image 618 directly benefit from the radiopharmaceutical produced by the elution system 10 having electronic pinch valves as illustrated and described with reference to FIGS. 1-6.

A test system including features in accordance with present embodiments was tested for 12 months review. Specifically, the test system contained two pinch valves and an adjusted generator system. The pinch valves were operated by an electronic switch device, which was setup in two consecutive circuits. A first circuit corresponded to “elution” and a second circuit corresponded to “elution break off,” and off. The components of the test system included an ULTRA TECHNEKOW (UTK) elution system (TYCO part number: E6-11273), which is a Technetium generator, with inactive aluminum oxide columns (TYCO part number: E6-11271), an OMNIFIT pinch valve (BIO-CHEM VALVE INC. part number: 075P2NC12-01S), and a 12V power supply.

Several tests were performed using the test system. The materials utilized in the tests included a UTK eluent 100 ml (TYCO part number: N5-70497), a technevial 11 ml (TYCO part number: N6-11571) and a stopwatch. The results of these tests indicated that the test system was comparable with existing systems. The details of each of the tests are set forth below.

In a first test (Test 1), an elution was initiated by placing a UTK eluent 100 ml and a technevial 11 ml (e.g., vacuum vial 20) on the elution system. Upon positioning the eluent and technevial, the test system's switch was set to “elution.” The time span between switching and elution was measured. That is, the amount of time between activating the switch to begin the elution and initiation of the actual elution was measured. The test was then repeated using a manually operated system with mechanical clamps. These steps were repeated and measurements were taken six times for both systems. For each elution, a new technevial was utilized. The results of these tests are set forth below in Table 1. It should be noted that in Table 1, “Elution” corresponds to a run number, “Elution (yes/no)” indicates whether the clamp on the generator opened and eluent ran through the system, and “Time” represents the amount of time measured between activating the system switch to initiate the elution and actual initiation of the elution.

TABLE 1
Test 1

| | | |
|---|---|---|
| Elution | Elution (yes/no) | Time (sec) |

Elution system with electronic clamps

| | | |
|---|---|---|
| 1 | Yes | 3.19 |
| 2 | Yes | 2.06 |
| 3 | Yes | 2.35 |
| 4 | Yes | 1.85 |
| 5 | Yes | 2.25 |
| 6 | Yes | 1.66 |

Elution system with mechanical clamps

| | | |
|---|---|---|
| 1 | Yes | 2.78 |
| 2 | Yes | 2.63 |
| 3 | Yes | 2.81 |
| 4 | Yes | 1.72 |
| 5 | Yes | 1.88 |
| 6 | Yes | 2.54 |

Conventional systems often have issues with tubes sticking together due to the pinch force of mechanical clamps. The Time measurement in Table 1 was taken in relation to this issue. According to the data obtained from Test 1, the electronic clamps appear to have a comparable performance to that of their mechanical counterparts.

In a second test (Test 2), an elution was initiated by placing a UTK eluent 100 ml and a technevial 11 ml on the elution system. The weight of the technevial was measured in advance. Upon positioning the eluent and technevial on the system, the test system's switch was set to “elution.” The time span between switching to “elution” and the complete fill of the technevial was measured. Further, the weight of the filled technevial was measured. The test was then repeated using a manually operated system with mechanical clamps. These steps were repeated and measurements were taken six times for both systems. For each elution, a new technevial was utilized. The results of these tests are set forth below in Table 2. It should be noted that in Table 2, “Elution” corresponds to a run number, “Elution (yes/no)” indicates whether the clamp on the generator opened and eluent ran through the system, “Time” represents a measurement of the amount of time required to completely fill the vacuum vial (e.g., vacuum vial 20) of the test system, “Weight empty” represents the weight of the vacuum vial before elution, “Weight full” represents the weight of the vacuum vial after elution (e.g., the vial plus the 11 ml of eluent), and “Flow” represents a calculation of eluent flow. The values for “Flow” were calculated by converting the weight (g) of the eluent to volume (ml) by dividing the weight by density (1 g/ml) and, then, dividing the volume (ml) by time (min).

TABLE 2
Test 2

| | | | | | | |
|---|---|---|---|---|---|---|
| | Elution | Time | Weight | Weight | Weight | Flow |
| Elution | (yes/no) | (sec) | empty (g) | full (g) | (g) | (ml/min) |

Elution system with electronic clamps

| | | | | | | |
|---|---|---|---|---|---|---|
| 1 | Yes | 42.50 | 12.5177 | 23.4041 | 10.8864 | 15.37 |
| 2 | Yes | 39.88 | 12.4667 | 23.5201 | 11.0534 | 16.63 |
| 3 | Yes | 39.78 | 12.2380 | 23.2348 | 10.9968 | 16.59 |
| 4 | Yes | 40.03 | 12.3931 | 23.5329 | 11.1398 | 16.70 |
| 5 | Yes | 39.90 | 12.3578 | 23.3912 | 11.0334 | 16.59 |
| 6 | Yes | 40.22 | 12.3870 | 23.4301 | 11.0431 | 16.47 |

Elution system with mechanical clamps

| | | | | | | |
|---|---|---|---|---|---|---|
| 1 | Yes | 48.28 | 12.4370 | 23.2549 | 10.8179 | 13.44 |
| 2 | Yes | 47.21 | 12.5231 | 23.6062 | 11.0831 | 14.09 |
| 3 | Yes | 46.47 | 12.3985 | 23.4418 | 11.0433 | 14.26 |
| 4 | Yes | 46.60 | 12.4887 | 23.5040 | 11.0153 | 14.18 |
| 5 | Yes | 46.16 | 12.4244 | 23.4596 | 11.0352 | 14.34 |
| 6 | Yes | 47.44 | 12.4111 | 23.5616 | 11.1505 | 14.10 |

FIG. 10 is a plot illustrating elution time and flow (ml/min) per system. The data designated as corresponding to System 1 in FIG. 10 was obtained from the system with electronic pinch valves and the data designated as corresponding to System 2 was obtained from the system with mechanical clamps.

In a third test (Test 3), an elution was initiated by placing a UTK eluent 100 ml and a technevial 11 ml on the elution system. The weight of the technevial was measured in advance. Upon positioning the eluent and technevial, the test system's switch was set to “elution.” The time span between switching to “elution” and filling half of the technevial was measured. The elution was halted by switching the system to “elution break off.” Further, the weight of the half-filled technevial was measured. The test was then repeated using a manually operated system with mechanical clamps. These steps were repeated and measurements were taken six times for both systems. For each elution, a new technevial was utilized. The results of these tests are set forth below in Table 3. It should be noted that in Table 3, “Elution” corresponds to a run number, “Elution (yes/no)” indicates whether the clamp on the generator opened and eluent ran through the system, “Elution break off (yes/no)” indicates whether the system stopped the elution when the switch was set to “elution break off,” “Time” represents a measurement of the amount of time between start and break off of the elution, “Weight empty” represents the weight of the vacuum vial before elution, “Weight full” represents the weight of the vacuum vial after partial elution (e.g., the vial plus an amount of eluent), “Weight” represents the actual weight of the eluent obtained by subtracting the value for “Weight empty” form the value for “Weight full,” and “Flow” represents a calculation of eluent flow. The values for “Flow” were calculated by converting the weight (g) of the eluent to volume (ml) by dividing the weight by density (1 g/ml) and, then, dividing the volume (ml) by time (min).

TABLE 3
Test 3

| | | | | | | | |
|---|---|---|---|---|---|---|---|
| | | Elution | | | | | |
| | Elution | break off | Time | Weight | Weight | Weight | Flow |
| Elution | (yes/no) | (yes/no) | (sec) | empty (g) | full (g) | (g) | (ml/min) |

Elution system with electronic clamps

| | | | | | | | |
|---|---|---|---|---|---|---|---|
| 1 | Yes | Yes | 10.16 | 12.4213 | 15.8461 | 3.4248 | 20.23 |
| 2 | Yes | Yes | 20.25 | 12.4648 | 18.671 | 6.2062 | 18.39 |
| 3 | Yes | Yes | 30.12 | 12.3456 | 21.4335 | 9.0879 | 18.10 |
| 4 | Yes | Yes | 9.87 | 12.511 | 15.6264 | 3.1154 | 18.94 |
| 5 | Yes | Yes | 20.00 | 12.3681 | 18.5525 | 6.1844 | 18.55 |
| 6 | Yes | Yes | 30.00 | 12.442 | 21.4569 | 9.0149 | 18.03 |

Elution system with mechanical clamps

| | | | | | | | |
|---|---|---|---|---|---|---|---|
| 1 | Yes | Yes | 10.00 | 12.4073 | 15.4437 | 3.0364 | 18.22 |
| 2 | Yes | Yes | 20.22 | 12.4679 | 17.625 | 5.1571 | 15.30 |
| 3 | Yes | Yes | 30.12 | 12.5013 | 20.1313 | 7.63 | 15.20 |
| 4 | Yes | Yes | 10.09 | 12.3862 | 14.9686 | 2.5824 | 15.36 |
| 5 | Yes | Yes | 20.28 | 12.5122 | 17.6431 | 5.1309 | 15.18 |
| 6 | Yes | Yes | 30.16 | 12.4969 | 20.0305 | 7.5336 | 14.99 |

FIG. 11 is a plot illustrating elution brake off and linearity elution time based on the data from Test 3. The data designated as corresponding to System 1 in FIG. 11 was obtained from the system with electronic pinch valves and the data designated as corresponding to System 2 was obtained from the system with mechanical clamps.

Based on the aforementioned results obtained in Tests 1, 2, and 3 for the test system in accordance with present embodiments, present embodiments are comparable in operation with a system containing mechanical clamps. However, present embodiments facilitate a slightly higher flow. The slightly higher flow obtained with the system containing electronic pinch valves may be attributed to the improved opening of the pinch valves in comparison to that of the mechanical clamps.

When introducing elements of the present invention or various embodiments thereof, the articles “a”, “an”, “the”, and “said” are intended to mean that there are one or more of the elements. The terms “comprising”, “including”, and “having” are intended to be inclusive and mean that there may be additional elements other than the listed elements. Moreover, the use of “top”, “bottom”, “above”, “below” and variations of these terms is made for convenience, but does not require any particular orientation of the components.

While embodiments of the present invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A radioisotope elution system, comprising:
a flexible radioisotope elution line; and
an electronic pinch valve disposed externally about the flexible radioisotope elution line, wherein the electronic pinch valve includes a remote electronic control connector.

2. The radioisotope elution system of claim 1, wherein the radioisotope elution line comprises an eluent input line, an eluate output line, an input vent line, and an output vent line.

3. The radioisotope elution system of claim 1, wherein the electronic pinch valve comprises a single electronic pinch valve having a plurality of constriction components disposed externally about different lines of the flexible radioisotope elution line.

4. The radioisotope elution system of claim 1, comprising a plurality of electronic pinch valves, including the electronic pinch valve, disposed externally about different lines of the flexible radioisotope elution line.

5. The radioisotope elution system of claim 1, comprising an eluate collection container, an eluent supply container, a radioisotope generator, or a combination thereof coupled to the flexible radioisotope elution line.

6. The radioisotope elution system of claim 1, comprising a radiation shield having a radioisotope generator cavity, wherein the electronic pinch valve and at least part of the flexible radioisotope elution line is disposed inside the radioisotope generator cavity.

7. The radioisotope elution system of claim 1, comprising a remote electronic control coupled to the electronic control connector.

8. The radioisotope elution system of claim 1, wherein the radioisotope elution line comprises an eluent input line having a first end coupled to an inlet of a radioisotope generator and a second end coupled to an eluent supply bottle, a supply vent line having a first end coupled to the eluent supply bottle and a second end coupled to a supply vent, an eluate output line having a first end coupled to an outlet of the radioisotope generator and a second end coupled to an eluate collection bottle, and an eluate vent line having a first end coupled to the eluate collection bottle and a second end coupled to an eluate vent.

9. The radioisotope elution system of claim 8, wherein the electronic pinch valve is disposed externally about the eluate output line.

10. The radioisotope elution system of claim 9, wherein the electronic pinch valve is disposed externally about the eluate vent line or a second electronic pinch valve is disposed externally about the eluate vent line.

11. The radioisotope elution system of claim 9, wherein the electronic pinch valve is disposed externally about the supply vent line or a second electronic pinch valve is disposed externally about the supply vent line.

12. A radioisotope elution system, comprising:
a radioisotope generator;
an elution line coupled to the radioisotope generator, wherein the elution line comprises a resilient circumferential wall disposed about a passage; and
an electronic pinch valve disposed externally about the resilient circumferential wall.

13. The radioisotope elution system of claim 12 wherein the electronic pinch valve includes a remote electronic control connector.

14. The radioisotope elution system of claim 12, comprising a remote electronic control coupled to the electronic control connector.

15. The radioisotope elution system of claim 12, wherein the electronic pinch valve is disposed at least partially inside the radioisotope generator.

16. The radioisotope elution system of claim 12, comprising an auxiliary shield disposed about the radioisotope generator.

17. The radioisotope elution system of claim 12, wherein the elution line includes an eluent supply line, an eluate output line, a vent line, or a combination thereof.

18. The radioisotope elution system of claim 12, wherein the elution line includes an eluent input line having a first end coupled to an inlet of the radioisotope generator and a second end coupled to an eluent supply bottle, a supply vent line having a first end coupled to the eluent supply bottle and a second end coupled to a supply vent, an eluate output line having a first end coupled to an outlet of the radioisotope generator and a second end coupled to an eluate collection bottle, and an eluate vent line having a first end coupled to the eluate collection bottle and a second end coupled to an eluate vent.

19. The radioisotope elution system of claim 18, wherein the electronic pinch valve is disposed externally about the resilient circumferential wall of the eluate vent line, or the supply vent line, or a combination thereof.

20. The radioisotope elution system of claim 18, wherein the electronic pinch valve is disposed externally about the resilient circumferential wall of the eluate vent line, or the eluate output line, or a combination thereof.

21. A method, comprising:
electronically manipulating a state of at least one electronic pinch valve disposed externally about at least one resilient flow line of a radioisotope elution system between constricting and not constricting the at least one resilient flow line to control elution of a radioisotope generator.

22. The method of claim 21, comprising controlling elution by generally increasing or decreasing a pressure differential between an elution container and a remaining portion of the radioisotope elution system via the at least one electronic pinch valve.

23. The method of claim 21, comprising opening or closing the at least one electronic pinch valve externally about an eluate output line of the radioisotope elution system.

24. The method of claim 21, comprising opening or closing the at least one electronic pinch valve externally about an eluent supply line of the radioisotope elution system.

25. The method of claim 21, comprising controlling elution of the radioisotope generator by eliminating suction in an eluate collection bottle that is driving elution by facilitating normalization of the eluate collection bottle by opening the at least one electronic pinch valve.

26. The method of claim 21, comprising controlling elution by creating suction in an eluent supply bottle of the radioisotope elution system by closing the at least one electronic pinch valve to block a supply vent line of the radioisotope elution system.

27. The method of claim 21, comprising remotely actuating the at least one electronic pinch valve.

28. The method of claim 21, comprising shielding radioactivity passing through the radioisotope elution system.

29. A container of a radioisotope produce by the method of claim 21.

30. A syringe of a radioisotope produced by the method of claim 21.

31. An image acquired from a radioisotope produced by the method of claim 21.

32. A method of nuclear imaging using a radioisotope from the method of claim 21.
